(19) United States
(12) Patent Application Publication
(10) Pub. No.: US 2003/0140059 A1
(43) Pub. Date: Jul. 24, 2003

(54) Set representation system and computer program

(75) Inventor: Takashi Ishizaka, Tokyo (JP)

Correspondence Address: Scott A. Chapple, Dobrusin & Thennisch PC, Suite 311, 401 South Old Woodward Avenue, Birmingham, MI, 48009, US

(73) Assignee: Beacon Information Technology Inc.

(21) Appl. No.: 10/348,449

(22) Filed: Jan. 21, 2003

(30) Foreign Application Priority Data
Jan. 21, 2002 (JP) 2002-11456

(51) Int. Cl. G06F 7/00

(52) U.S. Cl. 707/103 R

(57) ABSTRACT

A set representation system is provided that enables the operator to immediately understand set manipulation instructions and calculation results of such instructions.

Sets and set groups are hierarchically organized and the hierarchical structure is displayed on the display device DP, so that set groups in the relatively upper level of the hierarchy are created as a result of logical operation on all sets or set groups belonging to the lower level of the hierarchy thereof.

A graphic palette area is displayed on the display device DP, where for a plurality of sets or set group at the same level of the hierarchy, graphics having areas corresponding to their respective element counts can be drawn independently; for a plurality of sets or set groups at different levels of the hierarchy, divided graphics having area ratios corresponding to element counts in all sets or set groups belonging to the lower level of the hierarchy thereof can be drawn within the graphic associated with the set group in the relatively upper level of the hierarchy.

### CROSS REFERENCE TO RELATED APPLICATION

The present application claims priority from Japanese Application No. 2002-11456 filed Jan. 21, 2002, the disclosure of which is hereby incorporated by reference herein.

### FIELD OF THE INVENTION

The present invention relates to data management systems, and more specifically to a GUI (Graphical User Interface) technology for storing, as a concept of sets, search results for data stored in a database and analyzing them through combination of sets.

### BACKGROUND OF THE INVENTION

With a database management system (DBMS), when it comes to searching data relevant to certain search criteria from a database, the operator typically inputs the search criteria into the DBMS, which extracts data that matches the search criteria entered.

However, it has been found that if a search is conducted repeatedly using the same search criteria, retaining the result of data search as a set would eliminate the need for repeating the same search criteria, thereby improving the response for attaining the same result. It has also been found that if the search results retained in that way are further subjected to set operations, processing equivalent to multi-conditional searches for the DBMS can be achieved quickly.

When such a database management system is implemented, instructions for operations that combine sets are typically provided in the form of logical expressions.

Additionally, as an approach to conducting a set operation in a more visual manner, a method has been proposed whereby Venn diagrams that visually represent the relationship among sets are used (Unexamined Japanese Patent Application KOKAI Publication No. H6-89309, “Method for Processing Database Searches by Schematization of Sets”).

This method presents the quantities of database search sets and the logical relationships between sets (sum, difference, product, etc.) in a graphic fashion, and selects a rectangular area on the graphic to perform mathematic operation on sets, thereby enabling the user to point to a rectangular area on the graphic and extract relevant data easily. According to this method, each portion for a product, sum, difference, and so forth between sets can be recognized at a glance, and the element count in each set portion can be represented as an area ratio, so that the operator can advantageously understand the results of manipulation intuitively.

However, with the method that represents the search results or the like by use of Venn diagrams, there is a limitation in that up to three relationships may only be represented simultaneously on the same plane because relationships between sets are drawn on the plane. That is because the relationship among three sets may be logically handled by eight combinations thereof, whereas the relationship among four sets logically entails sixteen combinations, which cannot be represented on the plane at the same time. However, there may be many cases where more than three sets are to be handled when analytical processing is performed by combination of sets in reality. Let us assume the following sets, for example.

Set A1: Set of customers who purchased product A

Set A2: Set of customers who purchased product B

Set A3: Set of customers who purchased product C

Set B1: Set of customers whose business category is manufacturing

Set B2: Set of customers whose business category is distribution

Set B3: Set of customers whose business category is service

Set C1: Set of customers whose address is Tokyo

Set C2: Set of customers whose address is Kanagawa

Set C3: Set of customers whose address is Chiba

Set D1: Set of customers who have four or less employees

Set D2: Set of customers who have five or more and nine or less employees

For such sets, if customers who purchased product A; categorized as manufacturing; located in Tokyo; and having four or less employees are to be represented as a Venn diagram, it is necessary to determine a product set portion for Set A1, Set B1, and Set C1, and, using a single set for the resulting portion, determine a product set portion from a Venn diagram that overlays that single set and Set D1.

For a query that asks in which prefecture the customers who purchased product A are most concentrated among Tokyo, Kanagawa, and Chiba, it is not until combinations of Set A1 and Set C1, Set A1 and Set C2, and Set A1 and Set C3 are operated three times that the result is obtained.

Hence, there may be many cases where for analysis or mathematical operation that use sets, manipulations would be complicated by merely using a Venn diagram-based tool.

### SUMMARY OF THE INVENTION

Accordingly, it is an object of the present invention to provide an approach for enabling the operator to intuitively understand set manipulation instructions and results of mathematical operations thereof.

To solve the afore-described problem, the present invention provides a set representation system, which comprises: a set management means for creating a set group by grouping sets, or a collection of data that belongs to a certain conditional scope, and for deriving a relative relationship between a plurality of sets created, between a set and a set group, or between a plurality of set groups; and a processing means for causing a predetermined display device to quantitatively represent individual sets or set groups, while maintaining the relative relationship with other sets or set groups.

Said processing means causes said display device to display a plurality of palette areas for quantifying sets or set groups of the same contents in multiple representation formats that are different from each other.

Said processing means is such that each of said plurality of palette areas quantifies, when a set or set group that has been quantified in another palette area is imported into its own area by a drag-and-drop operation, that set or set group in the representation format thereof in real time.

Additionally, the present invention provides a set representation system, which comprises: a set management means for creating a set, or a collection of data that belongs to a certain conditional scope, and a set group that groups a plurality of sets, and for hierarchically storing the set and set group created in a predetermined storage device; a processing means for causing a hierarchical structure of the set and set group stored in said storage device to be displayed on a predetermined display device, wherein said set management means creates a set group that is at a relatively higher level of the hierarchy, as a result of logic operation on all sets or set groups that belong to its lower level of the hierarchy; wherein said processing means causes said display device to display a graphic palette area, where for a plurality of sets or set groups at the same level of the hierarchy, graphics having areas corresponding to the element count thereof can be drawn independently; for a plurality of sets or set groups at different levels of the hierarchy, divided graphics having area ratios corresponding to the element count for all sets or set groups that belong to the lower level of the hierarchy thereof can be drawn within said graphic.

From the standpoint of facilitating comparison between the numbers of elements of various sets, said processing means causes said display device to display a single or multiple alternative palettes, in place of or in conjunction with said graphic palette area, where a certain set or set group can be drawn simultaneously, while maintaining a relative relationship with another set or set group.

When a plurality of graphics are to be drawn in said graphic palette area, the problem is to determine the size of the graphic palette area. Hence, said processing means unifies drawing scales for graphics in said graphic palette area to a common scale, and determines the display size of said graphic palette area based on a graphic of a larger size among the graphic already drawn and graphics to be additionally drawn.

According to a preferred embodiment, when said graphic palette area is displayed on said display device, said processing means allows mutual transfer of substantial data contents of a set or set group drawn in each region to be conducted between said graphic palette area and said single or multiple alternative palette areas.

From the standpoint of facilitating operations performed by the operator who performs the operations while viewing on the display device, said processing means may also be configured to offer the following features:

(1) When another set group that is different from the set group already drawn in said graphic palette area is externally specified, a logical operation is performed on the element count for all sets and set groups belonging to lower levels of the hierarchy of said another set group, and divided graphics representing the relative ratio of said element count as a area ratio are additionally drawn in said graphic palette area.

(2) Under the condition where graphics for a plurality of set groups are drawn in said graphic palette area, when a drawing area for a set in a certain graphic and a drawing area for a set in another graphic are externally specified, a logical product operation on both sets is performed, and a subset graphic where the magnitude of the resulting product set is represented by the length thereof is superimposed on each of the two drawing areas specified.

(3) Under the condition where graphics for a plurality of set groups are drawn in said graphic palette area, when a drawing area for a set in a certain graphic and an entire portion of another graphic are externally specified, a logical product operation is performed between said set and all sets and set groups represented by said another graphic, and a subset graphic where the magnitude of the resulting product set is represented by the length thereof is superimposed on said drawing area and each of the drawing areas for the sets and set groups in said another graphic.

(4) The entire portion of said graphic is specified by selecting a name of the relevant set group.

(5) Said external specification is done by a drag-and-drop operation performed by the operator.

(6) Auxiliary lines are drawn linking a pair of subset graphics that are superimposed as different graphics, thereby facilitating relative comparison between the element counts thereof. In this case, more preferably, when a drawing area for a specific set or set group with said auxiliary lines drawn is specified, all the auxiliary lines drawn in said drawing area are highlighted.

(7) When said graphic, said divided graphic, or said subset graphic is specified, said display device is caused to display an area for displaying data stored in said storage device corresponding to said specified graphic, divided graphic, or subset graphic.

Said processing means can perform processing to handle at least one of said alternative palette areas as a Venn diagram palette for drawing Venn diagrams. More specifically, the processing means converts the results of logical operations for the set group or set specified to n-gonal Venn diagrams having areas corresponding to the magnitude of element count for each, and causes said display device to display, as said alternative palette area, a Venn diagram palette area for drawing each of the n-gonal Venn diagrams converted on the same screen, while maintaining a relative relationship with other n-gonal Venn diagrams. The greater the value of n, the higher is the flexibility for shapes of individual Venn diagrams, and the easier to represent the relative relationship with other Venn diagrams accurately, though it becomes more compute-intensive accordingly; thus, an appropriate value of n should be set in consideration of the number of sets and the magnitude of individual sets. Normally, the value of n ranges from 6 to 12.

To permit the relationship among search criteria to be visually recognizable depending on the display position of an n-gonal image, each set is converted to an n-gonal image having an area corresponding to the magnitude of element count of each set and a relative positional relationship based on the search criteria. The result of a data search by a logical product of search criteria is represented by an overlap of n-gonal images converted from the sets of the respective search criteria. The shape and area of the n-gon that provides a basis for the n-gonal image can be identified by mathematical operation. For example, they may be derived by repeating a convergence calculation for drawing under predetermined restricting conditions. In that case, the convergence calculation starts under restricting conditions for a convex polygon, and attempts to switch to restricting conditions for a concave polygon if it does not converge to a convex polygon after a certain number of repetitions.

It should be appreciated that the value of n may be changed a posteriori. That is, if the magnitudes of some of the sets are extremely different from those of other sets, the relative relationship among the Venn diagrams could not be displayed appropriately at the same time; if such is the case, adjustments can be made a posteriori to make the display format easier to view by changing the value of n.

Furthermore, the present invention provides a computer program. The computer program, when read and executed by a computer system to which the storage device and display device are connected, causes said computer system to act as the set representation system described above.

### BRIEF DESCRIPTION OF THE DRAWINGS

Referring to the drawings wherein like characters indicate like parts throughout the various figures:

FIG. 1 is a schematic diagram of a data management system according to an embodiment of the present invention;

FIG. 2 is a diagram illustrating an example of contents of an object ID table;

FIG. 3 is a diagram illustrating an example of contents of set storage area;

FIG. 4A is a diagram illustrating an example of data search results for “companies with two employees” in a database structure B;

FIG. 4B is a diagram illustrating the state where the search results are converted to an object ID list;

FIG. 5 is an explanatory diagram defining a portion of a hierarchical structure of sets in a set folder;

FIG. 6 is an explanatory diagram defining a portion of a hierarchical structure of sets in a set folder (continued from FIG. 5);

FIG. 7 is a screen snapshot presenting the state where a set is dragged and dropped from the Set Explorer onto the Set Palette;

FIG. 8 is a screen snapshot presenting the state where another set is dragged and dropped onto the Set Palette;

FIG. 9 is a diagram (product set) illustrating characteristic portions of the Set Palette, where Set “5-9” is dragged and dropped onto the area of Set “Generic Plate”;

FIG. 10 is a diagram (product set) illustrating the state where Set “30-49” are dragged and dropped onto the area of Set “Building Plate” under said condition;

FIG. 11 is a diagram illustrating the state where a set is dragged and dropped onto the Set Group Name;

FIG. 12 is a diagram illustrating the state where another set is dragged and dropped onto the Set Group Name under said condition;

FIG. 13 is a diagram illustrating the state where a set is dragged and dropped between Set Names under said condition;

FIG. 14 is a diagram illustrating that by double-clicking a certain set, highlighted lines for all subsets included in that set are drawn;

FIG. 15 is a diagram illustrating that by double-clicking another set, highlighted lines for all subsets included in that set are drawn;

FIG. 16 is a diagram illustrating the state where another set is dragged and dropped onto the Set Palette and its subsets are dragged and dropped;

FIG. 17 is a diagram illustrating the state where a subset is dragged and dropped onto the Set Viewer; and

FIG. 18 is a diagram illustrating the state where the Venn Diagram Palette is displayed as well.

### DETAILED DESCRIPTION OF THE PREFERRED EMBODIMENT

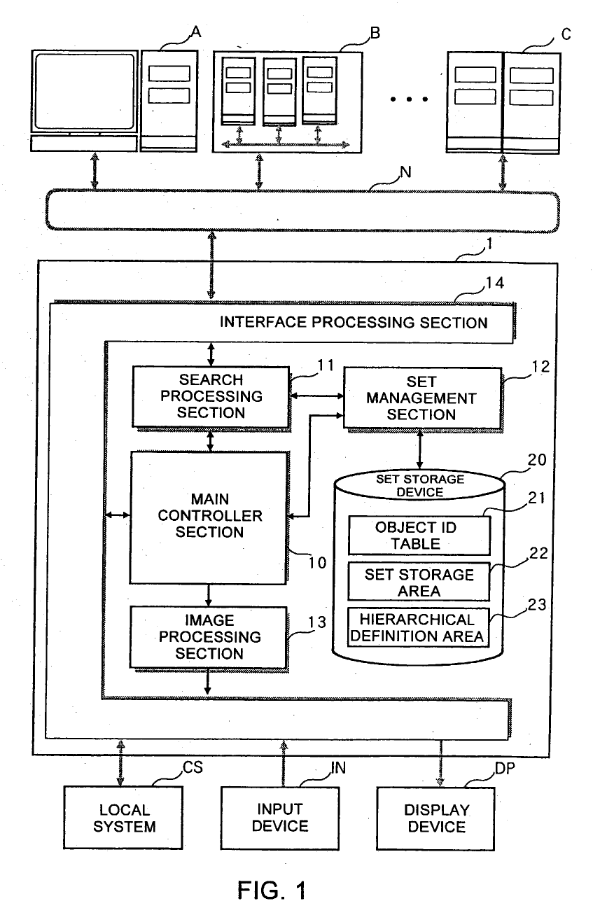

A set representation system of the present invention is described below with reference to an embodiment where it is applied to a data management system that manages, as sets, search results from a plurality of database structures. FIG. 1 is a schematic diagram of a data management system 1 according to the present embodiment.

The data management system 1 is implemented by a computer connected to an external storage device, such as a hard disk, a display device DP, and an input device IN; and a computer program of the present invention, which is read and executed by the computer. The computer includes a function of performing bidirectional communication among a plurality of database structures A, B, and C via a network N, and a function of performing bidirectional communication with a local system CS connected to a local area network (not shown).

The database structures A, B, and C are external servers that store data that provides a basis for sets, data warehouses, or other data storage means; it has a mechanism for conducting a data search in response to a request from the data management system 1 and outputting the search result thereof to the data management system 1.

It should be appreciated that although three database structures A, B, and C are presented in FIG. 1 for the sake of simplicity of explanation, there may be one database structure, or four or more database structures.

In the present embodiment, as the computer executes the computer program, a main controller section 10, a search processing section 11, a set management section 12, an image processing section 13, and an interface processing section 14 are formed as functional blocks in the computer, and the external storage device is used as a set storage device 20.

[Functional Configuration of System]

The main controller section 10, which acts as a core of the data management system 1, comprehensively controls initiation, shutdown, and collaboration of operations for other functional blocks 11-14. It also analyzes the contents of search criteria entered to issue a search instruction, and outputs the search result to the search requesting end.

The main controller section 10 has a temporary storage area 10R comprised of a RAM or the like, where information that is temporarily generated is retained until it is eventually deleted or saved.

The search processing section 11 directs a data search toward the database structures A, B, and C in accordance with search criteria instructed from the main controller section 10, and collectively obtains search results in the form of listed files. Non-listed search results may be listed by the search processing section 11. The list may contain codes (customer codes, etc., if customer data is applicable) for identifying elements of sets.

The set management section 12 collects as sets the lists obtained from the search processing section 11, and hierarchically manages the respective sets according to the set theory concept.

For collecting as sets, sets having identical or similar implications are grouped and organized in folders. The folder is called a set folder. Whether implications are similar or not may be implemented by, for example, pre-assigning a common code to identical or similar implications and checking whether a set inputted matches that common code. Sets may also be classified as the operator inserts sets, as judged appropriately, into the hierarchical set folder that is pre-configured according to the purpose.

Here, “hierarchical management based on the set theory concept” means that the set folder in the upper level of the hierarchy is represented as a result of a logical operation, e.g., a result of a logical sum, for set folders or sets in the lower level of the hierarchy thereof, and that set folders may be handled as equivalents to sets. For example, Set Folder “1-4 Employees” is a logical sum of Sets “1 Employee”, “2 Employees”, “3 Employees”, and “4 Employees” in the lower level of the hierarchy thereof. Set Folder “1-9 Employees” may be represented by a logical sum of Set Folder “1-4 Employees” and Set Folder “5-9 Employees” in the lower level of the hierarchy thereof. If the lower level of the hierarchy is a set folder, an operation to determine a logical sum of its further lower level of the hierarchy is repeated. The lowest level of the hierarchy is not a set folder, but a set.

With such a hierarchical organization, sets to be really stored in the set storage device 20 are simple ones in the lowest level of the hierarchy, such as “1 Employee” and “2 Employees”; sets, such as “1-4 Employees”, may be defined as set folders in the upper level of the hierarchy. By providing such functionality to the set management section 12, the problem of having duplicate sets having similar implications as in the prior art can be avoided.

The image processing section 13 performs image processing to cause the display device connected to the computer to display the hierarchical structure of sets as an hierarchical image, and display in detail the contents of the individual set folders, sets, and data.

The interface processing section 14 performs bidirectional signal communication control between the database structures A, B, and C; control for receiving various instructions entered by the operator through the input device IN connected to the computer, or instructions from the local system CS and computer program; control for causing the display device DP to display the results of image processing by the image processing section 13; control for outputting the search results to the search requesting end; and so forth.

It should be appreciated that the search results obtained from the database structures A, B, and C are comprised of a list of individual data that meets search criteria, although data IDs may be managed with different code systems between the database structures A, B, C and the data management system 1. In consideration of that point, the data management system 1 includes a mechanism for unitary management by using a common code system for data IDs.

More specifically, the contents of the data items managed by the system, such as, for example, customers, employees, etc., are regarded as objects, and individual objects are identified by a common ID, or object ID. Then, the set storage device 20 stores an object ID table 21 (hereinafter described in detail) that defines a correspondence between an object code for identifying an object managed under the code system for each database structure and the afore-described object ID.

When search results are inputted, object IDs are assigned to all of them, thereby allowing for unitary management within the system. Hence, the data managed under different code systems between the database structures can be handled as a collection of commonly formatted data, thereby facilitating logical operations on them.

Using the list obtained from the database structures A, B, and C as a set, the data management system 1 includes a set definition mechanism for defining an implication for a set and storing that set, and a list import mechanism for importing the list of data that provides a basis for creating a new set, so that the set definition mechanism and list import mechanism are activated independently and concurrently. The set definition mechanism coordinates the respective database structures A, B, and C with the search processing section 11, so that when the set creation is completed, they may be disconnected from each other.

In order to obtain a list from the result of combining sets (which is also a set) while it is disconnected for the database structures A, B, and C, the list import mechanism, in the present embodiment, is provided with a minimum table where individual object IDs that identify set elements are mapped to objects (e.g., customer names, addresses, telephone numbers, etc.). Using this table, the operator may easily understand which object ID an object corresponds to. Furthermore, because there is no need to separately access the database structures A, B, and C that have objects, such as customer names, they may be disconnected. Of course, if the database structures A, B, and C are connected to the present system, more detailed objects can be searched.

According to such an approach, the data management system 1 need not be configured for direct connection with the database structures A, B, and C.

[Set Storage Device]

The set storage device 20 includes an object ID table 21, a set storage area 22, and a hierarchical definition area 23.

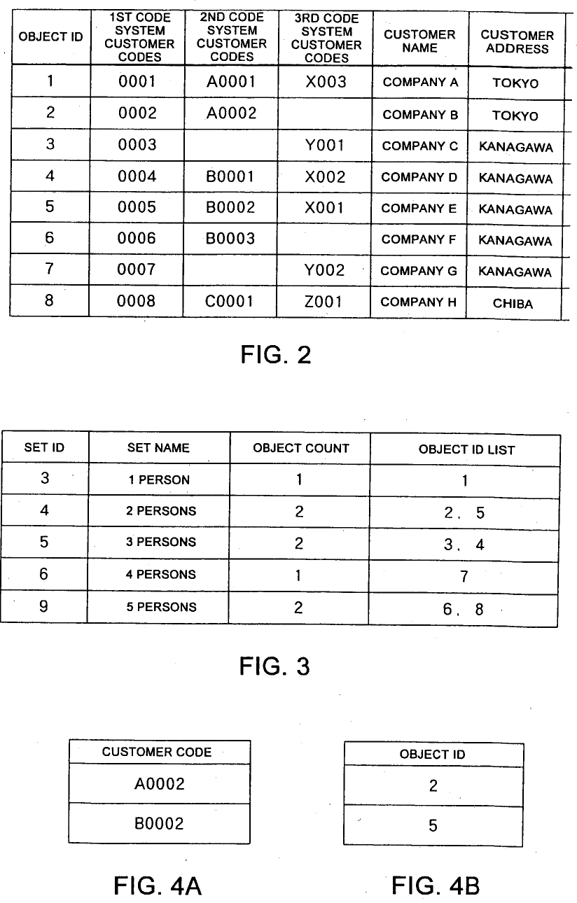

The object ID table 21, which is a conversion table for unitary management of search results as objects under the present system, as described above, provides a mapping or correspondence between object IDs and object codes used to identify data that provides a basis for creating sets. An example of object IDs is presented in FIG. 2.

In FIG. 2, customer code “0002” obtained by searching the database structure A having the first code system corresponds to object ID “2”; and customer code “A0002” obtained by searching the database structure B having the second code system similarly corresponds to object ID “2”. This example suggests that customer code “0002” of the database structure A and customer code “A0002” of the database structure B denote the same customer.

For object code ID “3”, it is suggested that there is a customer code corresponding to the database structures A and C, but for the database structure B having the second code system, there is no corresponding customer code.

In the object ID table 21, several management items for the object corresponding to its object ID, such as customer name, address, telephone number, etc., are set as mapped. These management items are established with the aim of making it easy to identify a request of interest when the operator makes a search request.

The set storage area 22 summarizes search results as objects, which are stored as sets. In the set storage area 22 are saved set definitions that represent contents of the sets. An example of the set storage area 22 is illustrated in FIG. 3.

In FIG. 3, “Set ID” is an ID for univocally identifying a relevant set in the set storage area 22 (its content is identified by “Set Name”). “Object ID List” is a collection of objects IDs for objects contained in the relevant set, and “Object Count” denotes the number of object IDs contained in the “Object ID List”.

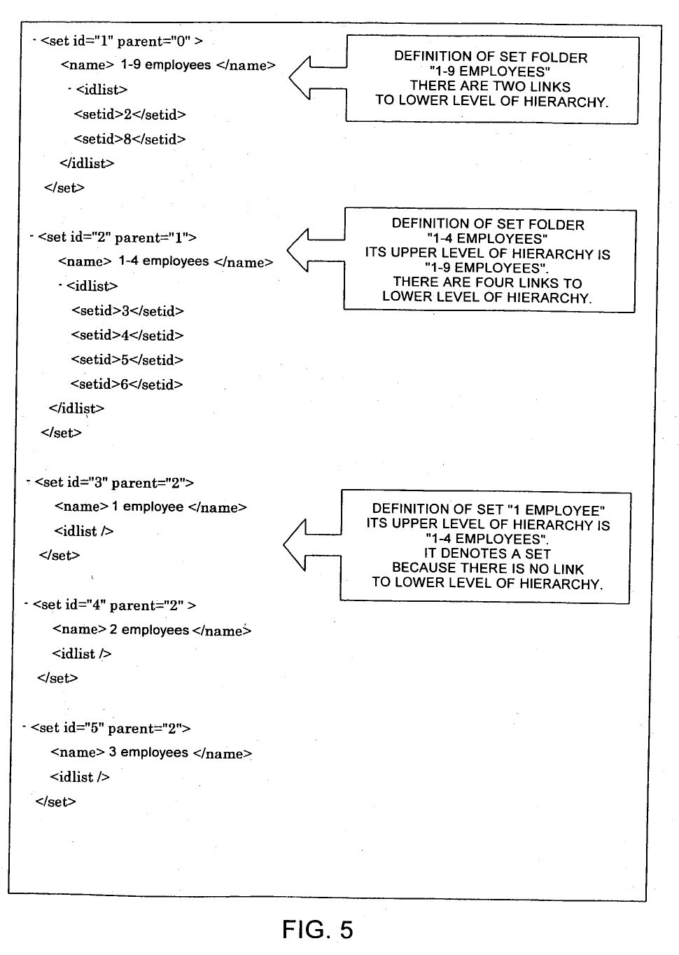

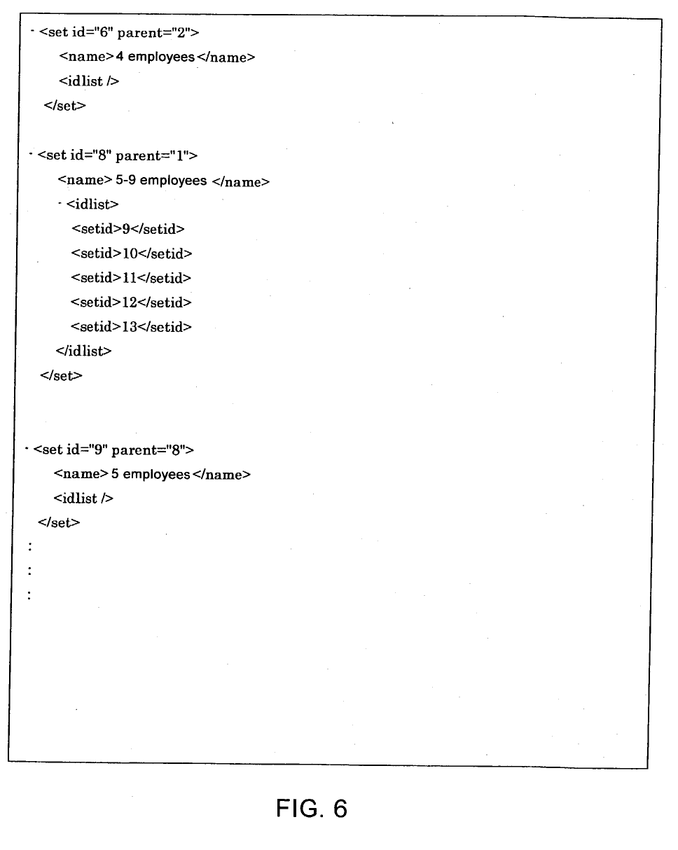

The hierarchical definition area 23 is an area for retaining definition information that defines the hierarchical structure of multiple sets. Although there is no specific limitation on the format for representing the hierarchical structure of sets, it is convenient to represent it in the XML format, at present. A definition example of the XML-formatted hierarchical structure is illustrated in FIGS. 5 and 6.

FIGS. 5 and 6 define a portion of the hierarchical structure of sets within a plurality of set folders. The definition information at the uppermost level of the hierarchy is for Set Folder “1-9 Employees, with two links to a lower level of the hierarchy thereof. The two links are associated with Set Folder “1-4 Employees” and Set Folder “5-9 Employees”.

Set Folder “1-4 Employees” includes four links to a further lower level of the hierarchy. The four links to the hierarchy are Set “1 Employee”, Set “2 Employees”, Set “3 Employees”, and Set “4 Employees”. They do not have any link to still lower levels of the hierarchy, which suggests that they are not set folders but sets.

Similarly, Set Folder “5-9 Employees” includes five links, at a lower level of the hierarchy thereof, Set “5 Employees”, Set “6 Employees”, Set “7 Employees”, Set “8 Employees”, and Set “9 Employees”.

[Operating Procedures]

Next, the operating procedures for the data management system 1 according to the present embodiment so configured are described, mainly referring to the processing performed by the main controller section 10. It should be appreciated that the main controller section 10 cooperates with the set management section 12 in terms of set management, cooperates with the search processing section 11 in terms of set search, and cooperates with the image processing section 13 in terms of display on the display device DP, although only the main controller section 11 is described here for the sake of convenience.

The data management system 1 provides a Graphical User Interface (hereinafter simply “GUI”) to the operator to permit him to search for a set of interest easily, while providing a concept of upper and lower levels of the hierarchy to sets, thereby preventing undesired duplication or omission of sets. In response to a GUI-based operation performed by the operator, the data management system 1 carries out various processes according to the operation.

More specifically, the GUI comprises a plurality of palette areas that is displayed on the display device and can be manipulated by the operator. One of the palette areas is a palette area that displays the hierarchical structure of sets. Such a palette area is hereinafter referred to as “Hierarchical Palette”.

The Hierarchical Palette appears on the screen of the display device DP as the operator clicks an certain icon on the main window (not shown) displayed on the display device. The on-screen position and size is either determined automatically by the system or specified by the operator.

From the set hierarchy displayed in the Hierarchical Palette, the operator selects a set group of interest to be analyzed by use of a pointer or the like. In so doing, a palette area for displaying, in graph form, the contents of individual set groups and sets is displayed together with the Hierarchical Palette. The palette area for displaying the graph is hereinafter referred to as “Graph Palette”.

The operator selects a set group or set of interest from the Hierarchical Palette, and issues a command to display it in the Graph Palette. As a typical approach to performing a series of such select and command operations, a well-known “drag-and-drop” technique is available. The present embodiment is described on the assumption that drag-and-drop operation is used, although it is not intended to be limited to such drag-and-drop operation.

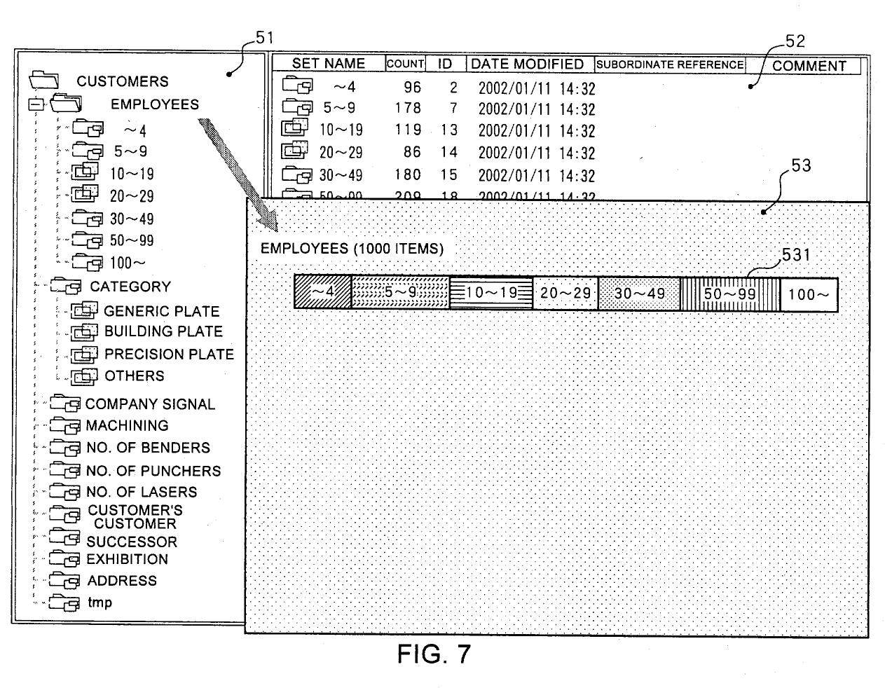

FIG. 7 shows the state where Set Group “Employees” is dragged and dropped from the Hierarchical Palette onto the Graph Palette. In FIG. 7, reference numerals 51 and 53 denote the Hierarchical Palette and Graph Palette, respectively. Reference numeral 52 denotes a detail display area for presenting in detail the contents of the Hierarchical Palette 51.

Upon detecting that Set Group “Employees” is dragged and dropped onto the Graph Palette 53, the main controller section 10 logically calculates a set sum for the number of elements in the lower-level set or set group of Set Group “Employees”. In the example shown in FIG. 7, a logical operation is performed on the respective numbers of elements for Set Groups “Up to 4”, “5-9”, “10-19”, “20-29”, “30-49”, “50-99”, and “100 or More”.

Next, an operation is performed to display a column graph on the Graph Palette 53 on the assumption that the sum of these elements is 100%, so that the column graph is drawn on the Graph Palette. Here, an important point is that the column graph is drawn so that the magnitude of each set is represented according to the number of elements in each set and/or set group.

By viewing the screen drawn in the form of a graph, the operator can understand, at a glance, how large the number of elements is for each set, and immediately ascertain which set contains most or least elements (in this example, which customer has the largest or smallest number of employees).

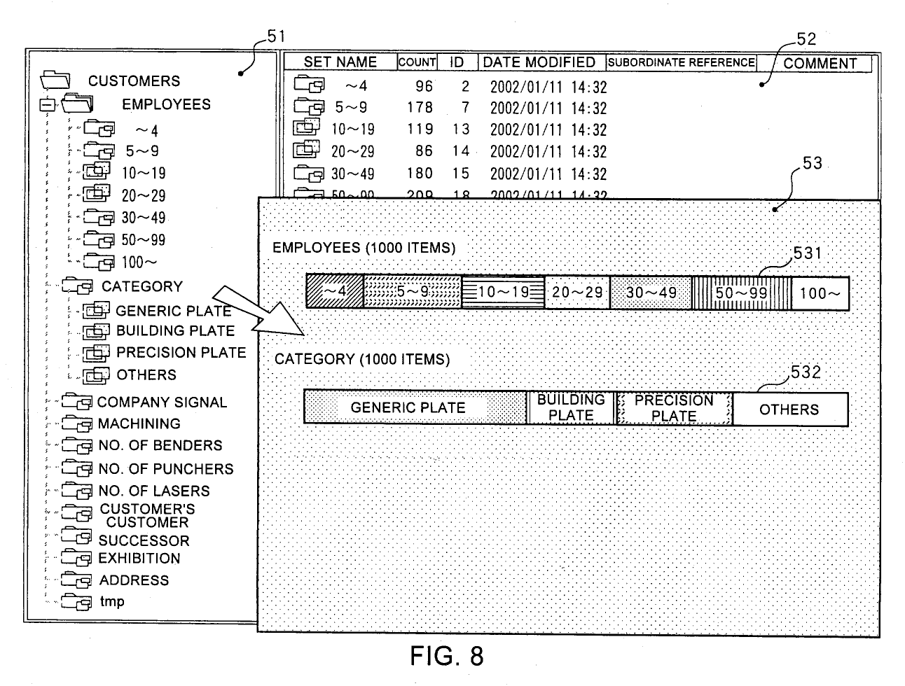

Under this condition, if the operator selects another Set Group “Category” from the Hierarchical Palette 51 and drags and drops it onto the Graph Palette 53, the main controller section 10 detects this drag-and-drop operation to perform a logical operation on the number of elements in the lower-level set or set group of the Set Group “Category” (i.e., determines a set sum from the Set Definition or further lower levels of the hierarchy). Then, a column graph is additionally drawn, as shown in FIG. 8.

In the example shown in FIG. 8, a column graph is drawn in the Graph Palette 53 on the assumption that the sum of elements for “Generic Plate”, “Building Plate”, “Precision Plate”, and “Others” is 100%. At this point in time, the size of the graph drawing region is determined by using either the total sum of elements for Set Group “Employees” already drawn or the total sum of elements in the current “Category”, whichever is larger. That is, when a plurality of set groups are drawn in the form of column graphs, elements in different categories may be intuitively compared in terms of their magnitude if the drawing scales for the graphs in the Graph Palette 53 are unified.

In the example shown in FIG. 8, comparisons can be made at the same time to see how many customers are assigned in the case where they are classified by number of employees and in the case where they are classified by category.

With the present system, a product operation between two different categories can be instructed on screen, under condition where a plurality of column graphs are drawn in the Graph Palette.

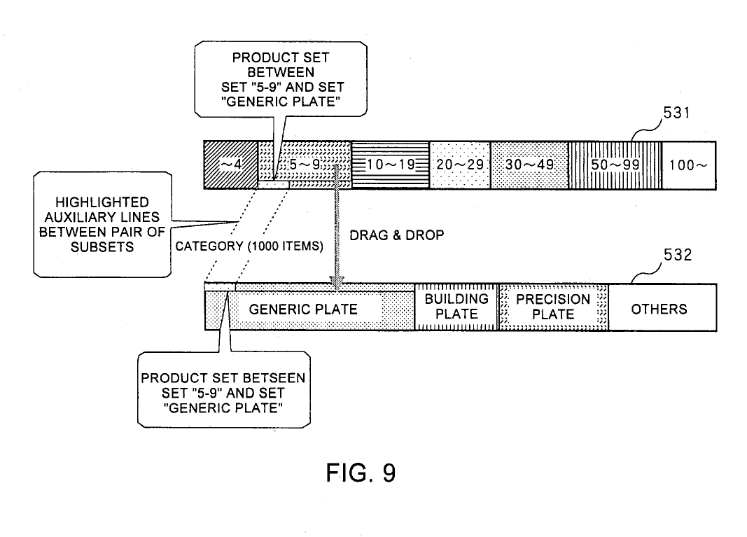

This procedure is explained with reference to FIG. 9.

FIG. 9 illustrates the result of a drag-and-drop operation performed by the operator, from a set portion (divided graphic) “5-9” belonging to the Set Group “Employees” displayed in the upper portion of the Graph Palette 53 onto a set portion (divided graphic) of “Generic Plate” belonging to the Set Group “Category” displayed in the lower portion thereof.

Upon detecting the drag-and-drop operation performed by the operator, the main controller section 10 calculates a logical product between Set “5-9” belonging to the Set Group “Employees” and Set “Generic Plate” belonging to the Set Group “Category”. This means that the number of customers who has 5-9 employees and whose category is Generic Plate is determined.

The main controller section 10 superimposes, as a subset of shape represented by the length thereof (subset graphic), the magnitude of the product set so determined over the respective set portions (divided graphics) of the original sets “5-9” and “Generic Plate”.

Thus, a logical product between the two sets “5-9” and “Generic Plate” is superimposed, as a subset of the original set portions, over the column graph.

Because the subsets are represented at two locations, those subsets are connected by auxiliary lines in the present embodiment, in order to emphasize that they are identical. Such auxiliary lines offer advantages in that a product portion between two sets can be easily understood by tracing their auxiliary lines; it can be seen at a glance which sets are used to generate that logical product; and the percentage of that logical product portion occupied in the original set can be intuitively ascertained.

The afore-described operation and the resulting contents drawn may also be determined in a similar manner for a product between other pairs of sets.

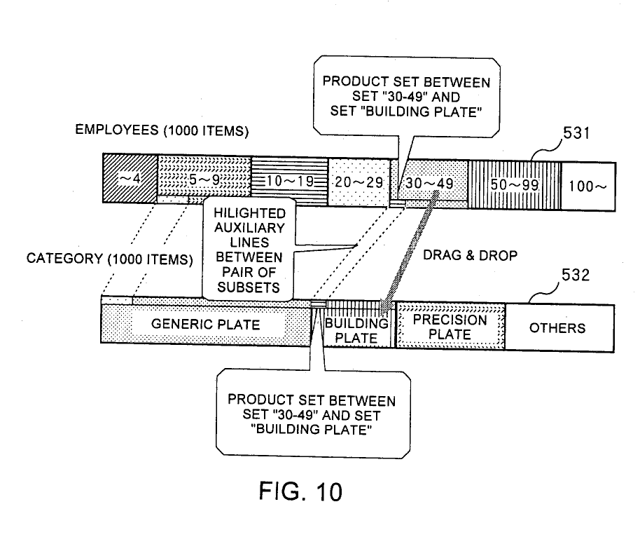

FIG. 10 illustrates the state where the operator drags and drops from Set “30-49” belonging to the Set Group “Employees” onto Set “Building Plate” belonging to the Set Group “Category”.

In this way, by linking a pair of sets of interest through a drag-and-drop operation between the set and the graph representing that set, a result of the logical product therebetween can be displayed immediately. Thus, the present system can provide a tool for powerfully assisting the operator's thinking.

Under the condition where set groups represented by a plurality of column graphs are displayed, a product operation between a set group and a set of different categories may be instructed. That means an operation performed on a certain set and all sets within a set group. This operation may provide an approach to simplifying the procedure for individually performing the afore-described logical product operations between sets, so that they will be done all at once.

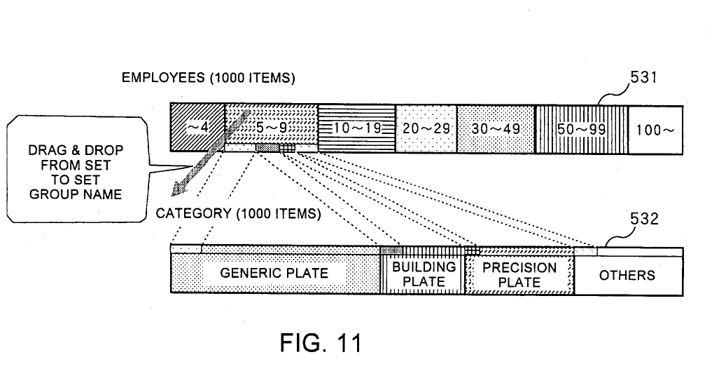

FIG. 11 illustrates a result of a drag-and-drop operation from a set portion of “5-9” belonging to the Set Group “Employees” onto the overall Set Group “Category” (by pointing to the Set Group name portion displayed on screen).

Upon detecting the drag-and-drop operation, the main controller section 10 calculates a logical product between a single set “5-9” belonging to the Set Group “Employees” and all lower-level sets of the Set Group “Category”. It then draws, in graph form, the magnitude of the product set determined for the respective sets in a similar manner to the afore-described method between sets.

By implementing this function, the operator can see, through a single operation, to which set of another set group a certain set correlates strongest or weakest (the magnitude of the product portion). In the example above, it can be seen, through a single drag-and-drop operation, which category the customers with 5-9 employees are most or least located in.

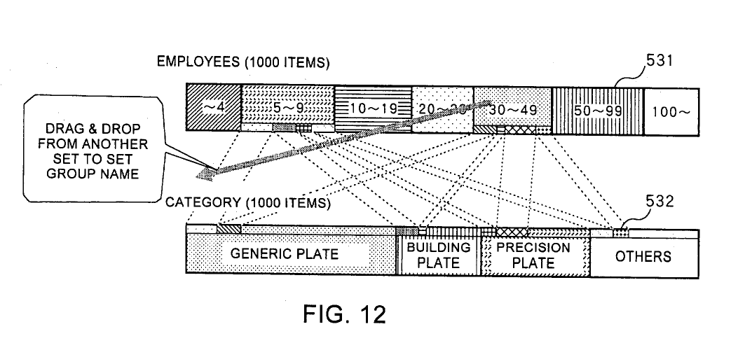

The afore-described operation and display may also be similarly determined in relation to other sets. FIG. 12 illustrates the state where a drag-and-drop operation is performed from Set “30-49” belonging to the Set Group onto the title of the Set Group “Category”.

Under the condition where a plurality of set groups graphed are displayed, a product operation between a pair of set groups in two different categories may be instructed. That means, an operation performed between all sets in a certain set group and all sets in another set group. It may provide an approach to further simplifying the procedure for individually performing the afore-described logical product operations between sets, so that operations between a pair of set groups will be done all at once.

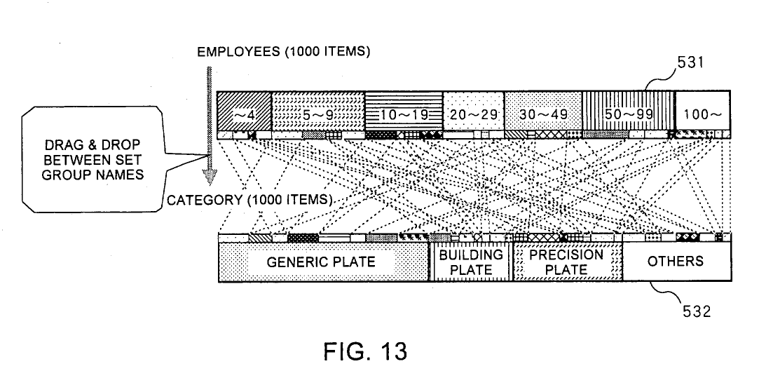

FIG. 13 illustrates the state where a drag-and-drop operation is performed from the Set Group “Employees” onto the Set Group “Category”.

Upon detecting such operation performed by the operator, the main controller section 10 calculates a logical product for combinations of all lower-level sets in the Set Group “Employees” and all lower-level sets in the Set Group “Category”. It then draws, in graph form, the magnitude of the product set determined for the respective sets in a similar manner to the afore-described method between sets.

By implementing this function, an operation can be conducted to determine, all at once, the correlation between each set in a certain set group and each set in another set group. In the example above, the correlation between the respective numbers of employees and the respective categories can be achieved through a single drag-and-drop operation.

As in the example above, the result of the product operation performed between a pair of set groups produces numerous auxiliary lines that indicate mapping between subset graphics for each set and subset graphics for its corresponding set. By carefully tracing the auxiliary lines, the correspondence between them may be seen; however, if such lines are too complicated as in FIG. 13, such a tracing task may not be easily done. In such cases, a certain set is specified, so that auxiliary lines are changed to highlighted lines that emphasize auxiliary lines associated with that set.

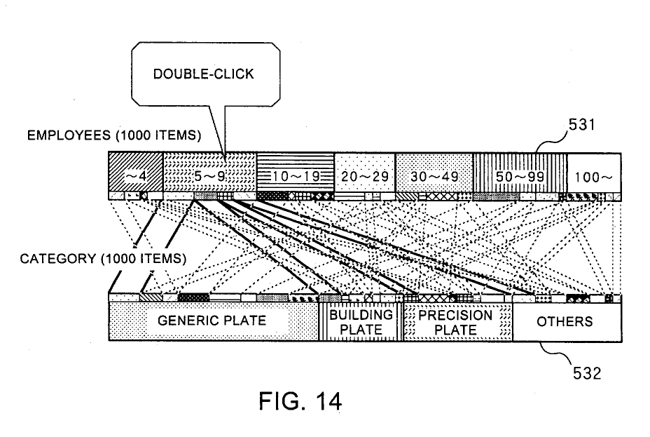

FIG. 14 illustrates the state where Set “5-9” is selected and double-clicked by the operator.

The main controller section 10 detects that a double-click on a certain set occurs and performs display processing that highlights auxiliary lines between subsets already determined for that set. This processing enables the operator to pick up highlighted lines among numerous auxiliary lines and easily identify a portion of interest.

It should be appreciated that the method by use of double-clicking has been described as a selecting method for processing to highlight auxiliary lines, although it is not intended to be limited to such double-clicking but other selecting methods may also be applicable.

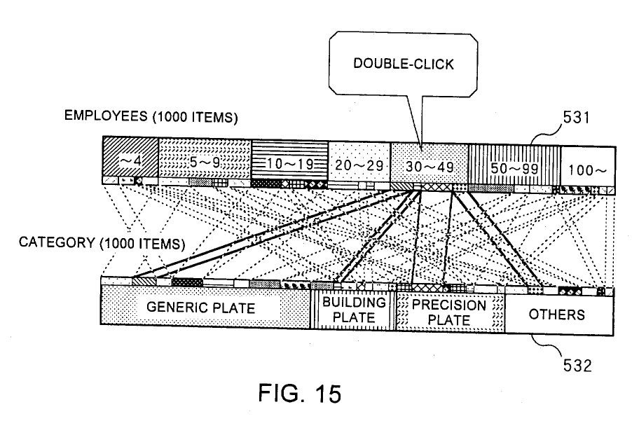

FIG. 15 illustrates the result of performing a similar operation on Set “30-49”. As shown in FIG. 15, if Set “30-49” is associated with a plurality of sets belonging to the Set Group “Category”, display processing is performed to highlight auxiliary lines for sets in all other set groups associated therewith.

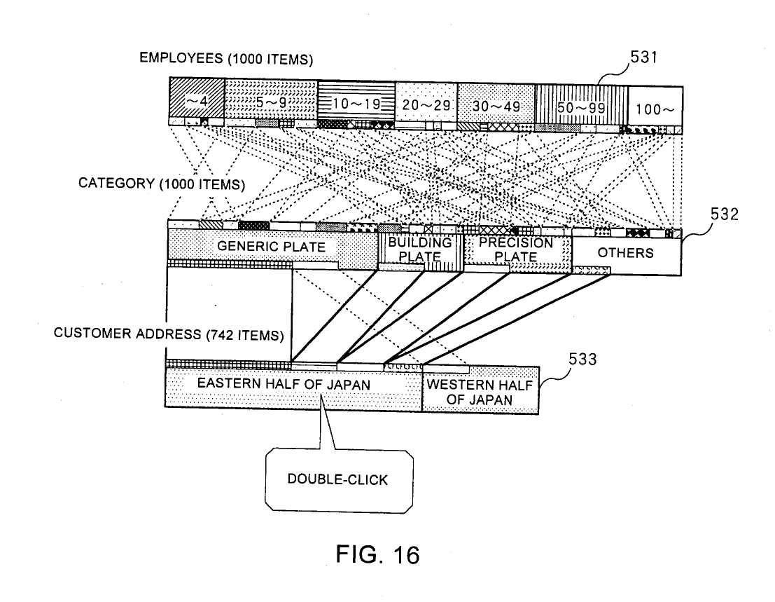

FIG. 16 illustrates an example where in addition to the correlation determined between the Set Group “Employees” and another Set Group “Category”, a new Set Group “Customer Address” is additionally drawn, and a correlation is determined between “Eastern Half of Japan” under that group and the Set Group “Category”, so that the relative relationship with the Set “Eastern Half of Japan” is further emphasized.

The data management system 1 also has a palette area, as one of many palette areas, for displaying the data contents that represent the contents of the set (e.g., if a customer is a set element, then the customer name, address, telephone number, and other attribute information of the customer). Because graphics are not drawn but data contents are merely displayed, this palette area is hereinafter referred to as the “Set Viewer”. The Set Viewer is activated by operating on a predetermined icon presented on the screen of the display device DV. The Set Viewer also permits sets and so forth to be copied through an drag-and-drop operation by the operator from other palette areas.

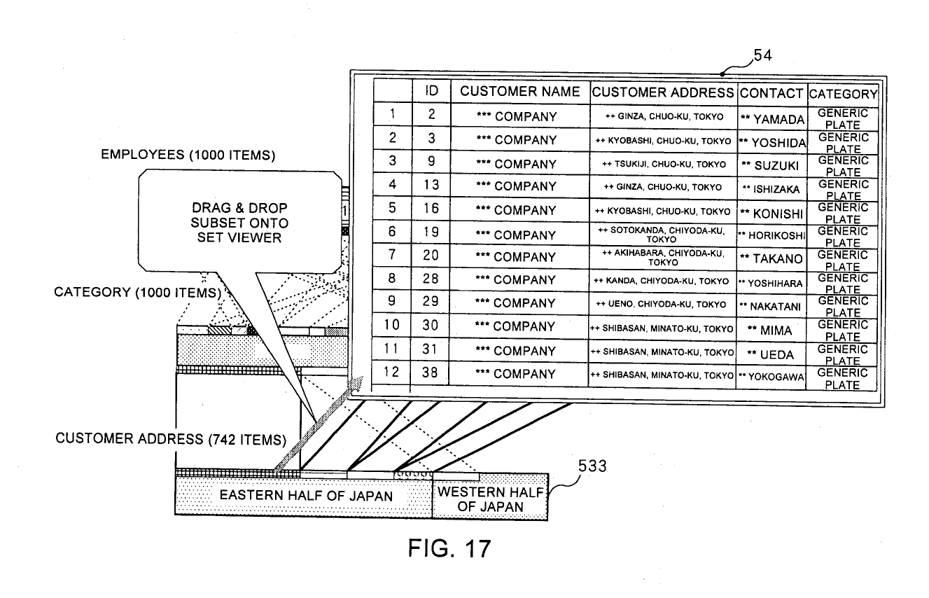

FIG. 17 illustrates the state where a product set portion (represented as a subset) between Set “Generic Plate” and Set “Eastern Half of Japan” is dragged and dropped onto the Set Viewer 54.

The operator drags and drop from a relevant set portion or subset graphic in the Hierarchical Palette 51 or Graph Palette 53 onto the Set Viewer 54. Upon detecting a drag-and-drop operation onto the Set Viewer 54, the main controller section 10 recognizes that displaying of sets has been instructed. It then determines a set that provides a drag starting point, and fetches from the object ID table 21 the contents of its set elements to be displayed, and presents them in the Set Viewer 54. In some cases, the database structures A, B, C may be queried through the search processing section 11, instead from the object ID table, to fetch the contents thereof.

The operator may check the contents of the set by merely selecting a desired set and dragging and dropping it onto the Set Viewer 11. The instruction for that has been described above with reference to the drag-and-drop operation, but other selecting methods may also be applicable.

It should be appreciated that a set may be dragged-and-dropped from the Hierarchical Palette 51 directly onto the Set Viewer 54. The Set Viewer 54 may also pass the contents displayed to other systems or the like by use of some method (typically via file transfer, etc.).

The method has been described for implementing a system that makes it easy to analyze, calculate, or display the contents of sets through drag-and-drop and double-clicking operations by use of segments of the Hierarchical Palette 51, Graph Palette 53 and Set Viewer 54, although a more sophisticated system associated with sets can be configured in conjunction with Venn diagram-based representations. A palette area for displaying Venn diagrams is hereinafter referred to as the “Venn Diagram Palette”.

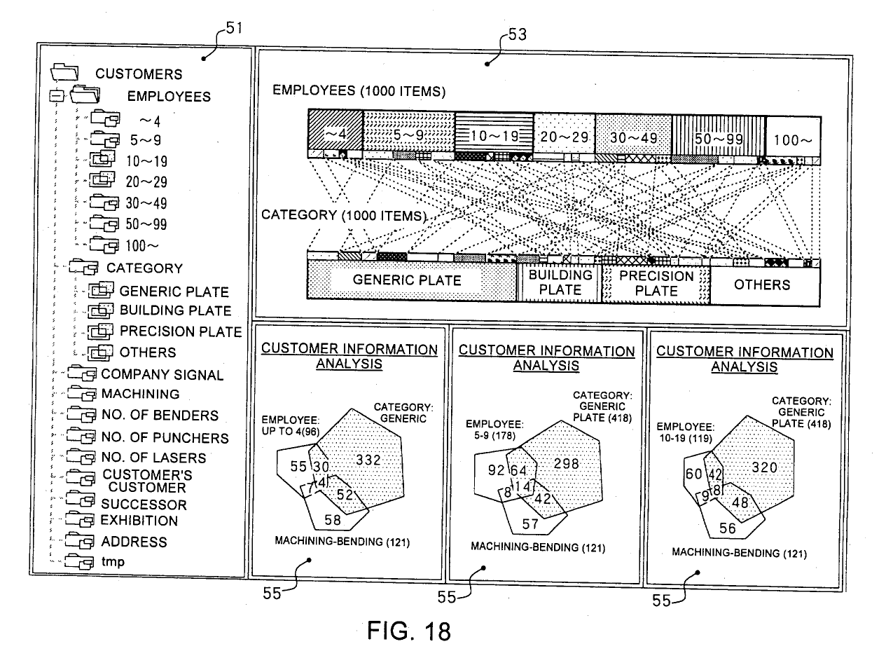

Upon receiving a certain icon manipulation or the like from the operator, the main controller section 10 controls the image processing section 13 to convert the result of logical operation for a specified set group or set to an n-gonal Venn diagram having an area corresponding to the magnitude of each element count, so that the Venn Diagram Palette may be displayed on the display device DP, where each of the n-gonal Venn diagrams converted is drawn on the same screen, while maintaining its relative relationship with other n-gonal Venn diagrams. An example of the Venn Diagram Palette is presented in FIG. 18.

In the example shown in FIG. 18, the Hierarchical Palette 51 and Graph Palette 53 are also activated at the same time, in addition to the Venn Diagram Palette. Under that condition, by merely selecting any set or subset in the Hierarchical Palette 51 or Graph Palette 53 into the Venn Diagram Palette 55 through a drag-and-drop operation, that set or subset may be drawn while maintaining the relative relationship therebetween. Any set portion in the Venn Diagram Palette 55 may also be drawn in the Graph Palette through a drag-and-drop operation. In this way, cross-compatibility is maintained.

For the Graph Palette 53 and Venn Diagram Palette 55, a plurality of identical ones may be activated at the same time; between the palettes, any set or subset, or any set portion on the Venn Diagram Palette 55, may be selected through a drag-and-drop operation. By using such functionality, various types of set analysis and computation may be achieved through GUI operation alone.

In this way, with the data management system 1 of the present embodiment, graphs having area ratios corresponding to the number of elements in each set of different set groups can be juxtaposed in the Graph Palette 53; thus, as in the above example, not only comparisons for the number of customers according to the number of employees, but also comparisons for the number of customers as classified by business category, can be done simultaneously, so that comparisons for the number of customers can be done concurrently in terms of employees and categories.

Additionally, because the correlation between the sets or set groups juxtaposed is represented by graphics, it is quite easy to make a comparison between a plurality of sets or set groups and perform a logical operation upon a combination thereof.

The data management system 1 of the present embodiment is not merely a mechanism for managing sets that are organized hierarchically, but is beneficial as an approach to quantitatively comparing sets or set groups under the vertical and horizontal levels of the hierarchy. Additionally, because the operator can intuitively understand the relative relationship among a plurality of sets or set groups through a single operation, a user-friendly interface can be provided.

Furthermore, because a GUI environment can be provided where a plurality of palette areas that represent sets and so forth in different formats can be displayed in combination, even very sophisticated analysis and/or manipulation may be achieved merely through a simple operation.

It should be appreciated that, in the present embodiment, an example of the data management system configured based on set groups organized hierarchically has been shown and described, although the hierarchical configuration of the sets is just a preferred embodiment of the present invention and is not indispensable. The present invention may be implemented with a simpler configuration where several sets are managed as groups.

The Graph Palette 53, Set Viewer 54, and Venn Diagram Palette 55 may be prearranged, so that the startup process may be simplified. Such pre-arrangements may also be memorized for each user. Furthermore, a sequence of steps performed by the operator for the Hierarchical Palette 51, Graph Palette 53, Set Viewer 54, Venn Diagram Palette 55, and so forth may be memorized and replayed later again. In so doing, it would be easier for the operator to recheck the sequence. Under the condition where the data contents have been modified, the memorized sequence may be re-executed (not replayed). This functionality means that processing is automated through the memorized sequence. For re-execution, the sequence of steps may be displayed on screen; or the final result may be merely outputted without replay.

In the present embodiment, the size of sets or the like graphed has been explained in terms of the number of elements that comprise a set; however, the present invention may also be implemented even if it is a total of attribute values for such elements (e.g., sales amount or quantity of items).

Each area graphed has been explained in terms of set elements; however, the present invention may be implemented even if they are data hits obtained by directly searching the database or the like, or a total of certain hit items of data, or so forth, instead of sets.

Accordingly, as is clear from the description above, the present invention can provide an interface that enables the operator to immediately understand set manipulation instructions and calculation results of such instructions.

What is claimed is:

1. A set representation system, comprising:
a set management means for creating a set group by grouping sets, or a collection of data that belongs to a certain conditional scope, and for deriving a relative relationship between a plurality of sets created, between a set and a set group, or between a plurality of set groups; and
a processing means for causing a predetermined display device to quantitatively represent individual sets or set groups, while maintaining the relative relationship with other sets or set groups.

2. The set representation system according to claim 1, wherein:
said processing means causes said display device to display a plurality of palette areas for quantifying sets or set groups of the same contents in multiple representation formats that are different from each other.

3. The set representation system according to claim 2, wherein:
each of said plurality of palette areas quantifies, when a set or set group that has been quantified in another palette area is imported into its own area by a drag-and-drop operation, that set or set group in the representation format thereof in real time.

4. A set representation system, comprising:
a set management means for creating a set, or a collection of data that belongs to a certain conditional scope, and a set group that groups a plurality of sets, and for hierarchically storing the set and set group created in a predetermined storage device;
a processing means for causing a hierarchical structure of the set and set group stored in said storage device to be displayed on a predetermined display device,
wherein said set management means creates a set group that is at a relatively higher level of the hierarchy, as a result of logic operation on all sets or set groups that belong to its lower level of the hierarchy;
wherein said processing means causes said display device to display a graphic palette area, where for a plurality of sets or set groups at the same level of the hierarchy, graphics having areas corresponding to the element count thereof can be drawn independently; for a plurality of sets or set groups at different levels of the hierarchy, divided graphics having area ratios corresponding to the element count for all sets or set groups that belong to the lower level of the hierarchy thereof can be drawn within said graphic.

5. The set representation system according to claim 4, wherein:
said processing means causes said display device to display a single or multiple alternative palettes, in place of or in conjunction with said graphic palette area, where a certain set or set group can be drawn simultaneously, while maintaining a relative relationship with another set or set group.

6. The set representation system according to claim 5, wherein:
said processing means unifies drawing scales for graphics in said graphic palette area to a common scale, and determines the display size of said graphic palette area based on a graphic of a larger size among the graphic already drawn and graphics to be additionally drawn.

7. The set representation system according to claim 5, wherein:
when said graphic palette area is displayed on said display device, said processing means allows mutual transfer of substantial data contents of a set or set group drawn in each region to be conducted between said graphic palette area and said single or multiple alternative palette areas.

8. The set representation system according to claim 4, wherein:
when another set group that is different from the set group already drawn in said graphic palette area is externally specified, said processing means performs a logical operation on the element count for all sets and set groups belonging to lower levels of the hierarchy of said another set group, and additionally draws divided graphics representing the relative ratio of said element count as a area ratio, in said graphic palette area.

9. The set representation system according to claim 4, wherein:
under the condition where graphics for a plurality of set groups are drawn in said graphic palette area, when a drawing area for a set in a certain graphic and a drawing area for a set in another graphic are externally specified, said processing means performs a logical product operation on both sets, and superimposes a subset graphic where the magnitude of the resulting product set is represented by the length thereof, on each of the two drawing areas specified.

10. The set representation system according to claim 4, wherein:
under the condition where graphics for a plurality of set groups are drawn in said graphic palette area, when a drawing area for a set in a certain graphic and an entire portion of another graphic are externally specified, said processing means performs a logical product operation between said set and all sets and set groups represented by said another graphic, and superimposes a subset graphic where the magnitude of the resulting product set is represented by the length thereof, on said drawing area and each of the drawing areas for the sets and set groups in said another graphic.

11. The set representation system according to claim 4, wherein:
under the condition where graphics for a plurality of set groups are drawn in said graphic palette area, when an entire portion of a certain graphic and an entire portion of another graphic are externally specified, said processing means performs a logical product operation between all sets or set groups represented by each of the graphics, and superimposes a subset graphic where the magnitude of the resulting product set is represented by the length thereof, on each of the drawing areas for the sets or set groups in both of the graphics.

12. The set representation system according to claim 10 or 11, wherein:
the entire portion of said graphic is specified by selecting a name of the relevant set group.

13. The set representation system according to claim 8 through 12, wherein:
said external specification is done by a drag-and-drop operation performed by the operator.

14. The set representation system according to claim 9, 10, or 11, wherein:
said processing means draw auxiliary lines linking a pair of subset graphics that are superimposed as different graphics.

15. The set representation system according to claim 14, wherein:
when a drawing area for a specific set or set group with said auxiliary lines drawn is specified, all the auxiliary lines drawn in said drawing area are highlighted.

16. The set representation system according to claim 9, 10, or 11, wherein:
said processing means causes said display device to display an area for displaying data stored in said storage device corresponding to said specified graphic, divided graphic, or subset graphic.

17. The set representation system according to claim 5, wherein:
said processing means converts the result of a logical computation for a set group or set specified to an n-gonal Venn diagram (n is a natural number) having an area corresponding to the magnitude of element count for each, and causes said display device to display, as said alternative palette area, a Venn diagram palette area for drawing each of the n-gonal Venn diagrams converted on the same screen, while maintaining a relative relationship with other n-gonal Venn diagrams.

18. A computer program, when read and executed by a computer system to which the storage device and display device are connected, causes said computer system to act as the set representation system according to either of claims 1 through 17.
